(19) United States
(12) Patent Application Publication
(10) Pub. No.: US 2001/0034638 A1
(43) Pub. Date: Oct. 25, 2001

(54) Server side processing of internet requests

(76) Inventors: John Kelley, Lexington, KY (US); Patrick J. Healy, Lexington, KY (US)

Correspondence Address: ROBERT B. HUGHES, HUGHES & SCHACHT, P.S., 2801 MERIDIAN STREET, SUITE 1, BELLINGHAM, WA, 98225-2412, US

(21) Appl. No.: 09/777,291

(22) Filed: Feb. 5, 2001

Related U.S. Application Data
(60) Provisional application No. 60/180,498, filed on Feb. 5, 2000.
(60) Provisional application No. 60/200,868, filed on May 2, 2000.

(51) Int. Cl. G06F 17/60

(52) U.S. Cl. 705/10

(57) ABSTRACT

A server side data tracking system adapted to track data packets at a server. The data packets adapted to store Internet surfing data by an end user.

### RELATED APPLICATIONS

This application claims priority of U.S. Provisional Application Ser. No. 60/180,498 and 60/200,868, which were filed Feb. 5, 2000 and Mar. 2, 2000, respectively.

### FIELD OF THE INVENTION

The present invention relates to server side processing of requests made by a client to a third party. More specifically, when the client makes the request to a third party through the ISP server, the ISP server receives a code from the client that designates the client's specific preassigned group. When the third party responds the ISP server scans this response and associates information from this response and correlated with the preassigned group the client belongs to.

### SUMMARY OF THE INVENTION

A data tracking system adapted to track Internet transaction activity by an end user's computer and track internet surfing in a data structure that contains information, regarding the end users preferences. The system comprises a data retrieval system that has a data scanning process adapted to scan data packets. The data retrieval system further has a first data storage process adapted to receive information from the data scanning process and store the data. The system further comprises a data storage system that comprises a database adapted to store the data (data structure). The data storage system further has a data retrieval process that has a connection system that is adapted to retrieve data form the first data storage process. The data comprises group id information that describes the end user.

### BRIEF DESCRIPTION OF THE DRAWINGS

FIG. 1 shows a schematic demographic diagram;

FIG. 2 shows a sample data structure;

FIG. 3 shows a schematic company and vendor relationship.

### DETAILED DESCRIPTION OF THE PREFERRED EMBODIMENT

The invention relates to Active Commerce Technology™ (ACT™) or otherwise known as Electronic Commerce Technology™ (ECT™) herein referred to as the data tracking application. Active Commerce Technology is a computer program that is installed with the dial-up service software provided by a program supplier. This program will reside on the hard drive of the user and is activated every time that the user goes on line. The program is activated by a ‘ping’ from the IP server of the network in addition to the user and password authentication. At this time, it re-assembles it's self every time a new web page is accessed. Therefor, if a user erases the cookie, the server can still identify the user. A user's identification is merely as a member of the program supplier member as well as the sponsoring member of the VSP™. At this time, the user is identified and a database showing the different web sites accessed and the number of visitors. In addition to the to the number of impressions, it also tracks the amount of money spent at the site.

In general, an Internet service provider (ISP) provides their clients with an installation package that allows the clients to access their server, which is connected to the Internet. One aspect of this installation package is to install a startup program which initiates dial-up networking or any other remote access program (e.g. a cable modem initiation program) that allows the clients contact the server and provide a username and password to log onto the server and have access to the Internet. The startup program continues to run on the client's machine and places a cookie or the data equivalent onto the local drive of the client's computer.

This cookie which is placed on the client's computer contains information specifically about the client. The information about this client is preassigned by the ISP or the ISP's delegated agent, which is discussed further below. One possible data structure that can be stored in this cookie is a six-digit code. The first three digits can designate which ISP or ISP agent is providing the service for this client. The second three digits designate what specific group this client is assigned to. This identification process is further discussed below.

After the client initiates the startup program and provides a username and password to the ISP's server, the client may now make requests to any Internet Protocol (IP) No. or URL on the Internet. It should be noted that the presently used protocol on the Internet is TCP/IP and all requests to the Internet must pass through the server of the ISP. When the user requests a specific URL from a third party, for example www.xxxABC-Coxxx.com, the TCP/IP packets are sent out to a domain server to resolve the specific IP address for this URL. At this point the server can detect the cookie on the client's machine to find out what group the client has been assigned to, and further, what URL the client is interested in viewing. This data is stored in a database where they client's cookie is stored in a client group field and the client's requested URL is stored in the client's requested URL field of a database. The time of the request can be another field in the database where the actual time the client made the request is stored therein in the same record.

In addition to storing the URL the client entered, the server can further store specific content sent between the client and the third party. When the client receives the specific IP address for the previously requested URL, the client's browser will now make requests to the IP address directly. It should be noted that at present the IP addresses are 32-bit numbers that uniquely identify a node on the Internet. Of course, when 64-bit numbers are employed, the underlying invention still pertains thereto. Now the client's browser directly requests the index page of the Internet port on the third party machine that has been designated the previously mentioned IP address. When the client makes a request to the third party Internet server, the ISP server can store the cookie of the client on the database in a client group field and further store the third party's IP address in a requested IP addresses field. As mentioned before, a time of request can be another field in the database which stores the time the client made the request in the same record. A further function the ISP server executes is scanning the TCP/IP packets that are sent from the client and the packets received from the third party to extract specific data and additionally store the data onto the database.

It is well known that the Internet is often used in commerce for commercial transactions. The ISP server has a data tracking system where comprising a data retrieval system that has a conventional packet scanning capability to detect when a commercial transaction is taking place and to find the dollar amount of this transaction. This dollar amount is then stored in the database on the server in a field designated as transaction total. The data retrieval process further has a first data storage process that is adapted to record the data scanned.

It should be noted that the client who signed up to the ISP provider is well aware of this scanning technology of the ISP and the ISP stores no information about the specific client, but rather, only stores information about what group the client belongs. In some scenarios the actual user can be identified with the Internet activity and the user will be stored in a user Id field on the database.

The information that is stored in the records of the aforementioned database ultimately benefits the client by providing significant statistical data that the ISP or the ISP's agent (further discussed below) can utilize to have a powerful bargaining position against third party online vendors. The ISP or ISP's agent can approach online vendors or businesses and request a discount from the online business's services. For example, say the ISP has 20,000 clients and the clients are designated into 10 equally sized groups of 2000 clients labeled A through J. The database on the server could reflect that a 30 percent of group D shops at www.ABC-Co.com and has spent $400,000 in the past year. Armed with this knowledge the ISP can negotiate a lower price from www.XxxABC-Coxxx.com for the ISP's customers in group D. Therefor the ISP is operating as a buying agent for their clients where the collective spending habits of their clients in a specific group is utilized for negotiating purposes. If the vender is not cooperative in providing the discounted price, the ISP or ISP's agent could not include that vender in the valued vender list that they provide to their customers. The ISP could then approach competing vendors to find out if they will give their clients a discount deal.

The information could further be used to sell advertising to vendors. If a group has spending habits on a certain class of product, venders of that class of product could compete for advertising space with the ISP or ISP's agent.

If the third party company is skeptical of the data the ISP or ISP's agent pertaining to the spending habits of the ISP's clients, the ISP can provide a program that remains on the third party's Internet server that will detect the number of hits and dollar amount spent of the ISP's clients in a specific group.

If the third party company decides to give the discount to the specific group of the ISP then the ISP can provide a program to the third party that runs on the third party's Internet server. This program will detect the cookie on the client's machine and specific content will then be sent to the client. For example, if group D has the demographics where they are interested in mechanical gadgets, then the third party company can provide web page content directed to the specific interests of this group. So www.xxxABC-Coxxx.com would direct web content of perhaps new mechanical gadgets on the index page specifically designed for group D.

The data that is tracked and stored in the data retrieval system is periodically uploaded to a data storage system that comprises a database to store the data structures. A retrieval process uses a connection system such as a common Internet packet routing protocol retrieve the data from the data retrieval system. The data storage system is a node that could be a server on the Internet.

A second aspect of the present invention is providing Internet service provider technology to organizations that are not equipped to becoming ISPs on their own. This technology is named Virtual Service Provider™ (VSP™) or Virtual Internet Service Provider™ (VISP™). The organizations that want to provide ISP service without dealing with the technological aspects are referred to as ISP agents where it appears that the ISP agent is providing Internet service directly where an actuality the ISP is handling the technological aspects of providing access to the Internet to the ISP agent's clients.

For example, let's assume there is a and organization referred to as DocU which is a fictitious union for doctors that provides information and services to all medical doctors in the United States. DocU may have periodicals and other means of conveying information to doctors; however, they now decide to utilize the Internet to give doctors Internet access and information through this access. At this point the ISP will step in and become a Virtual Service Provider™ (VSP™) for the organization DocU. The ISP will provide all of the technological aspects of assigning IP numbers, providing the startup software, the data lines, etc. but the organization DocU would appear to their clients to be Internet service providers.

The aforementioned active cookie technology would be utilized in this scenario. The distribution packet contains the startup software and specific information namely the VSP™ and the group in which the client is associated. For example, when a client of DocU, who is presumably a medical doctor, installs the startup software on his local machine the startup software would place a cookie on the local machine. In this case the VSP™ would be DocU and the group could be broken down into areas of medical practice. This information is stored on the cookie of the client's machine and the data collected from the client's activity on the Internet is then utilized by the ISP or ISP agent as described above.

Continuing with our example, let us assume a client is an orthopedic surgeon and she logs on to the Internet via the ISP. Using the VSP™ technology the startup program the cookie containing the Internet service provider information and the group of this client is placed on the client machine. If the cookie were erased, the startup program would replace it. In this case the first three digits of the cookie would designate DocU as the ISP's agent that is utilize in the VSP™ technology, and the second set of three digits would designate the group this to which the client belongs. In this case the group is a code which designates orthopedic surgeons. When the client logs onto the Internet the ISP provides a startup homepage that contains generic news and common Internet searching capability along with broad categories of content on the Internet along with specific content directed to this ISP agent and even to the specific group that belongs to this ISP agent. So along with the generic news specific news pertaining to the ISP agent can be intermingled therewith. Further, the banner or main title of this initial logon page can be chosen by the ISP agent. As in our example of DocU, they would provide their specific logo and trademark information on this initial logon page.

The ISP agent can use the data tracking application technology to provide a bargaining position for their clients so their clients can obtain better deals with third party vendors and companies. As described above, the ISP agent can review the reports from the database that is held at the ISP's server. The reports will show where specific groups that belong to the ISP agent spend time and money on the Internet. Armed with this knowledge, the ISP agent can approach the companies and vendors to obtain a better deal for their specific groups in their clientele. Of course the ISP agent can further sell Internet advertising that is targeted to specific groups. For example, if the reports from the server show that a pediatrician doctors group purchase large quantities of paper towels, then this information would entice paper towel manufactures to purchase advertising that is targeted to the pediatrician group.

The ISP would charge a flat fee for Internet access based on the number of customers they have committed. It would be the responsibility of the Virtual Service Provide to collect all fees related to charging customers for dial up access.

It should be noted that obviously the previous example explaining the VSP™ technology is by way of example only and of course not limited to medical doctors but applies to any group or association.

Instead of using the cookies on the client machine the ISP could track the IP number of the clients and the IP number range that are assigned to the ISP agent and further the ISP agent's groups. The IP number of the client can then be used to track their activity in a similar manner as mentioned above.

The technology can be purchased as a unit or individually. One aspect of the IBG™ technology is that after the data is collected and URPower or the VSP™ approach the manufacture. One aspect of the VSP™ is that any start page can be manipulated by the data tracking application technology. The data tracking application technology is integrated with the sign on protocol program (e.g. dial up networking) where you pass the password and User Id.

The data tracking application has the capability to manipulate the browser to adjust the start homepage that is displayed when the browser is loaded and started up and they connect to the Internet. Even if the user changes the start up page the Act will set the start up page to whatever the VSP™ desires. This can be executed through common automation schemes such as Component Object Modeling COM or Common Object Request Broker Architecture CORBA.

It should be noted that if the end user were to not use the dial up program that is used by the VSP™ to log on the internet then the data tracking application technology is not in processor space and is not in effect. To remedy this problem a plug-in that has the functions of the data tracking application could be implemented. The data tracking application technology is a plug-in that could be retrofitted to the Internet Browser using the standard plug-in architecture that are accepted by the common browsers. The plug-in would operate the data tracking application Technology and would not need the Dial up program to operate.

The benefit of this is the ability of plug-ins to be retrofitted to existing browsers, the end users will not need to reload the dial up system, but rather, use their existing Internet connection.

Another feature is to have the group authentication Id and other information associated therewith such as the VSP™ name to be burned into the hardware of the computer. One implementation of this would be that the information could be burned into the EPROM or CMOS of the chip on the computer. These computers would be distributed to the end users where the computers would have some indication that they are delivered from the VSP™. The CMOS could have an executable that would run the data tracking application technology. This could be provided by the computer manufactures themselves as they are sold to the groups. The data structure could be expanded to list several groups criteria. The sub classification for the end user could be for example doctors, doctor specialty, age, geographical location, etc. This group labeling would not directly invade the privacy of the end user, but can be used by the ACT to track his e-commerce activities and other activities on the Internet.

Intertwined with the IBG ad Act technology is numerical equivalent anonymity number. This number has been developed in academic institutions. The number of a group is 4999 to ensure that the group members, regardless of their activity on the internet (such as going to internet porn cites by accident or intentionally) is maintained in confidence because the group size is large enough where no individuals could be singled out or deduced by reviewing the activities of the group. So activities on the Internet that the end user would want to remain secret are kept so. The privacy of the individuals is maintained.

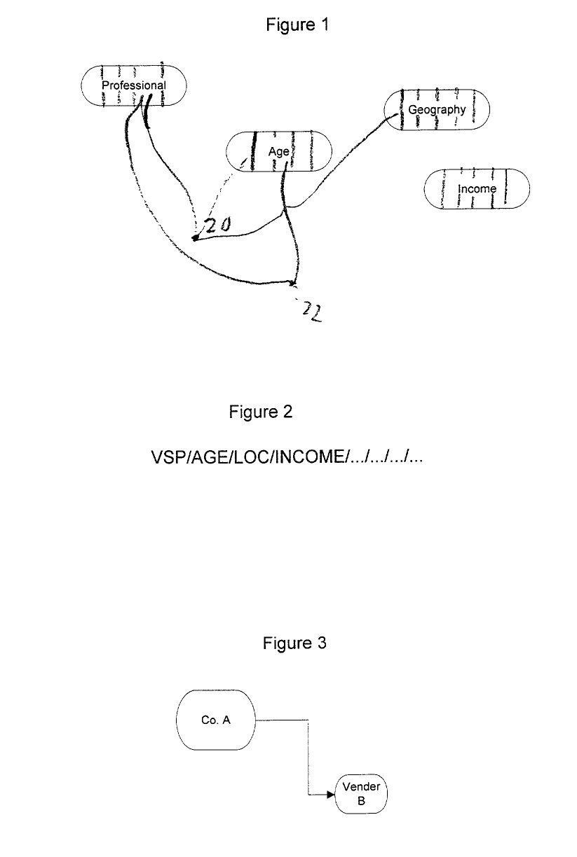

Another possibility of the data structure would be to have several groups. As seen in FIG. 1 there are several group headings in discrete sections. For example listed are profession, age, geography and income. Therebelow are dots representing individuals. For example, individual 20 is in the doctor group for the professional group heading, and in the 30-35 group for the age group heading. The individual is also doctor group for the professional group heading, but is in the 50-55 age group for the age group heading.

Referring to FIG. 2, there is a data structure that is incorporated with the data tracking application described supra. The data structure in this case is delineated by a slash (/) and in the leftmost portion is the VSP™ identifier followed by age, location, income, etc. of course a number of other groups could be listed that would be useful for product purchasing. The IBG™ technology and either the VSP™ utilize this information or main Internet supplier can execute data analysis. The data analysis can be executed on any of the subgroups mentioned above (age, occupation, geographical location, etc.). For example, the age group heading would be tracked irrespective the virtual service provider and this knowledge is used by the IBG™. Another feature discussed before to be stressed upon is that the van doors can be implemented with a day data tracking application receiving technology. As seen in FIG. 3, the user that belongs to the VSP™ group of, for example, Co. A goes to vendor B. on the Internet. Vendor B has implemented the ACT Receiving Technology™ (or reACT™) herein referred to as the receiving application or technology and can therefore recognize that the individual logging on it is part of the Co. A. group. The data structure that is shown in FIG. 2 is read by the receiving application and specific content is thereby displayed to this individual that is part of the specific group heading, and this case Co. A. of the VSP™ group heading. So if individuals from Co. A have certain products that they usually purchase, specific content can be directed to them when a logon. Another example would be the data tracking application receiving technology would put merit in the age category of the data structure. Therefore, if an individual of the eight—twelve year-old group in the age group heading category logs on to a vendor implementing the ACT Receiving Technology™, the vendor would displayed for example products catered to this age group. Another facet of the present invention is to be an application service provider (ASP) where the ASP would have a central location have a data processor, RAM, data storage means, data connection means (TCP/IP, satellite, ether net, token ring, or any other connection methods between computers). Client machines would logon the ASP where the ASP would provide the programs and processing of the commands are executed in the program can be shared between the client and the ASP. The programs could be word processing, spreadsheets, time and billing software, voice recognition software etc. one of the contingencies of providing the ASP service would be licensees must use the data tracking application technology. This information is collected and used with the IBG technology as well.

When the end user goes from a unsecured network to a secure network by the data tracking application data warehouse server and this indicates that a purchase is made in which case the packets will be scanned four characters that are commonly associated with purchases (for example, “$”) and this character will attempt to find the numerical value in this TCP/IP packet and the price would be identified with the groups that are in the data structure of FIG. 2. The actual items that were purchased by the individual do not need to be stored in the data warehouse and associated with the groups if this invade upon the privacy of the groups.

It should be noted that the groups in FIG. 2 are exemplary and any groups that are of interest to consumers and purchasers could be utilized.

Another option would be to include the identification numbers better associate with the product and store them in the data warehouse in association with the data structure as seen in FIG. 2. It should be noted that the store to the information can be done by partitioning out the groups of the data structure and associating the recorded data therewith. Therefore, it would be very difficult to deduce the individual by knowing what groups is in for example, if the user fits a unique group structuring profile where for example, are individual is a boy genius who is in the 15-20 group in the age group category and is also a doctor and the profession category. If an insidious hacker were to acquire the data structure as seen in FIG. 2 and find associated purchases with the data structure, it would be very easy to deduce that the person who made this purchase was the boy genius. The insidious hacker would simply find out the activities of the doctors who are also in the 15-20 age category and the boy genius essentially lost his anonymity. However, if the boy genius's purchase was immediately partitioned out respects to his groupings before any permanent storage has been done, then this deduction could not take place. For example, the purchase would be associated with the 15-20 group and a purchase would also be associated with the doctor group of the profession group heading. Therefore, it would not be possible to deduce that the same individual did the single purchase. Of course, if the exact time of the purchase is recorded then an insidious individual could theoretically correlate the exact times of purchases in different group headings to the same product or purchase price. The insidious individual would then find the specific groups with in the group headings where the matches have been made and find an individual that meets this group profile. To combat this intrusive endeavor, the time of the purchase can be recorded in a block, for example two-hour blocks on the hour. Therefore a purchase price in a two-hour block could have other similar purchases in many groups to make the deduction process extremely difficult to impossible. Another method of foiling the attempts of the insidious hacker would be to have the purchase price as well as the products in set categories that are recorded in the permanent storage. For example, the purchase price could be in $20 increments; therefore a purchase of $189.89 would be the same category as under $199.98. Therefore the insidious hacker would have a difficult time deducing the individual because there would be so much data within these time blocks and purchase price blocks in all of the categories. The group blocks are specific enough to provide meaningful data however are not specific enough to provide the opportunity for deducing the individual from the particular groups he belongs. Another group implementing option would be to identify the products in a group to remove the possibility of deduction for these purchases. For example the group heading of purchased product would contain specific groups such as hardware, cosmetics, grocery items, etc.

This information can be utilized by the vendor implementing the ACT Receiving Technology™ where the receiving technology would recognize the groups of interest the individual belongs to and identifying the purchasing habits of the respective groups the vendor is interested in. For example, the vendor may not be interested in the profession of the individual but may be interested in the geographical location. The information from these groups would provide specific content to the user base on his group identification. The vendor could focus on specific group headings and direct the content to cater towards the spending habits of individuals in that group.

Other information can be stored in identified with the groups in specific group headings. Such information could be the URL that was requested by the group member. For example, if there is a correlation of purchases that occur at a specific Web site then eventually the Web site owner could be contacted and the propositioned to becoming an ACT receiving agent implementing the ACT receiving technology.

It should be a data variety of programming languages could be utilized to implement the aforementioned technology namely XTML, extended HTML, Java, C++, Prologue, Fortran, Visual Basic, COBOL, JavaScript, Flash. Of course this is not an exhaustive list but merely exemplary to give the best disclosure for the public.

The data tracking application technology can be implemented on all Internet tight browsers including PalmPilots, cellular phones, personal computers of all operating systems, palm devices, etc. again, this list is not exhaustive but merely exemplary.

While the invention is susceptible of various modifications and alternative forms, specific embodiments thereof have been shown by way of example in the drawings and described in detail. It s should be understood, however, that it is not intended to limit the invention to the particular forms disclosed, but, on the contrary, the intention is to cover all modifications, equivalents and alternatives falling within the spirit and scope of the invention as expressed in the appended claims.

I Claim:

1. A data tracking system adapted to be located on a end user's computer and track data comprising details showing internet surfing activity where the data tracking program comprises:
a data retrieval system comprising,
a data scanning process adapted to scan data packets,
a first data storage process adapted to receive information from the data scanning process and store the data,
a data storage system comprising,
a data storage system comprising a database adapted to store the said data,
a retrieval process comprising a connection system adapted to retrieve data from the first data storage process.

2. The system as recited in claim 1 further comprising:
where the data comprises group id information that describes the end user.

3. The system as recited in claim 1 further comprising:
the data retrieval system is located on an ISP server providing internet connection to the end user.

4. A data tracking application adapted to record the internet surfing history of an end user having an internet browser that is defined by a group identification where the application comprises:
a storage system adapted to track internet surfing habits by storing the URL the end user,
a data structure comprising at least one URL and the group identification associated with the URL,
a central server having a retrieval system adapted to upload the data structure and store the data structure in a database.

5. The data tracking apparatus as recited in claim 4 further comprising:
where the storage system resides on a server that is the end users internet service provider.

6. The data tracking apparatus as recited in claim 4 further comprising:
where the group identification is a Cookie stored on the end user's computer.
